(19) United States
(12) Patent Application Publication
(10) Pub. No.: US 2023/0150834 A1
(43) Pub. Date: May 18, 2023

(54) FILTER ELEMENT, SEALING ASSEMBLY AND COFFEE MACHINE

(71) Applicant: Tianjin Yunda Industry And Trade Co.,LTD, Tianjin (CN)

(72) Inventor: Enyu WEI, Tianjin (CN)

(21) Appl. No.: 18/157,016

(22) Filed: Jan. 19, 2023

Related U.S. Application Data
(62) Division of application No. 17/321,522, filed on May 17, 2021.

(51) Int. Cl. C02F 1/00; A47J 31/06; C02F 1/28

(52) U.S. Cl. CPC C02F 1/003; A47J 31/0605; C02F 1/283; C02F 1/42

(57) ABSTRACT

Provided is a filter element comprising a filter element body having a cavity, a water inlet and a water outlet, an end cap, and a perforated partition, and the perforated partition is configured to divide the filter element body into a first chamber filled with an adsorption filter material and a second chamber filled with an ion exchange filter materials. In the present disclosure, the filter element is divided into two stages, and the primary filter material and the softening filter material are filled separately, and functions of both filtration and descaling are realized, addressing the issues blocking of water and reduced water flow in the coffee machine using a PP/PE filter element. Meanwhile, reduction in water flow caused by the mixing of the filter materials and the caking of the filter material is also solved.

### CROSS REFERENCE TO RELATED APPLICATION

This disclosure claims the priority of Chinese Patent Application NO. 202110419953.1 entitled “Filter element, sealing assembly and coffee machine” filed with the China National Intellectual Property Administration on Apr. 19, 2021, all of which are incorporated herein by reference in its entirety.

### TECHNICAL FIELD

The present disclosure relates to the field of filtration technology, in particular to a staged filter element, a sealing assembly, and a coffee machine including the filter element.

### BACKGROUND

At present, PP- (polypropylene) or PE- (polyethylene) sintered filter element is used as the end-stage filter element of the coffee machine. The internal filter material in the filter element is mixture of resin and activated carbon. Due to instability of the PP and PE filter element, the unstable porosity of the end-stage PP or PE filter element causes low water flow in the filter element, and the phenomenon of low water flow due to water flow through the filter element occur. Meanwhile, after long-time service of the filter element, the problems such as caking of filter material and compaction of the filter element are resulted, reducing the performance and efficiency of filter element in the coffee machine.

### SUMMARY

In view of the problems existing in the prior arts, the present disclosure provides a staged filter element. The filter element comprises a filter element body, a water inlet, a water outlet, an end cap, and the filter element further comprises a perforated partition in the filter element body, and the perforated partition is configured to divide the filter element body into at least two chambers, the at least two chambers include a first chamber and a second chamber, the first chamber is filled with an adsorption filter material, and the second chamber is filled with an ion exchange filter material.

In the present disclosure, the filter element is improved such that it has a staged filter element structure. In some embodiments of the present disclosure, the filter element is configured to a two-stage structure by arranging a perforated partition inside the filter element body through which water flow can pass. Since the filter element is divided into two stages, and the primary filter material (i.e. the adsorption filter material) and the softening filter material are filled separately, and functions of both filtration and descaling are realized, addressing the issues in the filter element in which PP/PE (polypropylene/polyethylene) are used as the end filter element of the coffee machine. The phenomenon that there is no water flowing out or there is reduced water flow is addressed. Meanwhile, the problem of low water flow in the filter element caused by the mixing of the filter material and the caking of the filter material is also solved. In addition, in the present disclosure, activated carbon and resin are separately filled on both sides of the perforated partition in the filter element to avoid filter material hardening caused by the mixing of two different filter materials. In addition, the water inlet, water outlet, and middle part of the filter element can be equipped with a perforated partition, which not only increases the water flow area of the water path in the filter element, but also avoids the low water output caused by uneven precision of PE and or PP sintered filter element.

In the present disclosure, the perforated partition may be any partitions that separate the filter material to avoid mixing of two filter materials, as long as it can separate the filter materials and allow water to pass through. For example, the perforated partition may be a filter cloth or a perforated grid. If the perforated partition is a filter cloth, the filter cloth can be configured in such a manner that the filter cloth is fixed by an annular ring in the center of the annular ring and the edge of the filter cloth can be integrally arranged with an annular ring; or two annular rings can be used to clamp the edge of the filter cloth to form a filter cloth assembly so that it can be arranged in the filter element body. In another embodiment, the perforated partition is a perforated grid. The perforated grid can be made of metal (for example, stainless steel), and the grid has holes of different shapes. The shape of the hole can be square, round, etc. An example of a perforated grid is a filter grid.

In this disclosure, the adsorption filter material may be a variety of adsorbents with active capabilities, for example, activated carbon. Adsorption filter material is mainly used to absorb residual chlorine in water and serves as the primary filtration of filter element. The ion exchange filter material can be a variety of filter materials having ion exchange ability, and it is used to remove metal ions in the water, soften the influent water, and serves as the secondary filtration of the filter element. For example, the ion exchange filter material is ion exchange resin.

In one embodiment of the present disclosure, the filter element further comprises a central pipe located inside the filter element body and extending in the longitudinal direction of the filter element body, the central pipe is configured to pass through the perforated partition, with one end of the central tube being connected to the water inlet where an inlet water filter mesh is provided, and the other end of the central pipe being connected to the water outlet where an outlet water filter mesh is provided;

the perforated partition surrounds the outer wall of the central pipe and extends to the inner wall of the filter element body so that the inlet water flows from the water inlet through the first chamber filled with the adsorption filter material and then through the second chamber filled with the ion exchange filter material, and flows through the outlet water filter mesh at the water outlet into the central pipe, then flows out at the other end of the central pipe.

In this embodiment, the inlet water flows in from the bottom of the filter element, enters the cavity of the filter element after preliminary filtration by the inlet water filter mesh, and flows through the filter material (for example, activated carbon and resin). After the inlet water is purified by the filter material, the water passes through the outlet water filter mesh and is discharged from the lower end of the central pipe. The inlet water filter mesh can be a flexible filter mesh or a rigid perforated grid, such as a filter grid. Some features of the filter mesh or perforated grid may be referred to the description in the above embodiment. The presence of the central pipe allows the water to flow in from the bottom, flow upward through the filter material, flow into the central pipe from the upper end of the central pipe, and then flow out from the lower end of the central pipe. In this arrangement, the water inlet and the water outlet are both located at the same side of the filter element, making the design of the filter element more compact and reducing the volume of the filter element.

It should be noted that in the present disclosure, there is no limitation to the order in which the first chamber and the second chamber are arranged. In other words, the first chamber may be located at the upper part of the filter element and filled with an adsorption filter material, and the second chamber may be located at the lower part of the filter element and filled with an ion exchange filter material. Alternatively, the second chamber may be located at the upper part of the filter element and filled with an ion exchange filter material, and the second chamber may be located at the lower part of the filter element and filled with an adsorption filter material.

In one embodiment of the present disclosure, the filter element further comprises at least two water inlet holes arranged at an end of the filter element, and the water inlet holes are spaced apart from each other by a water inlet rib. This arrangement allows the water to flow into the filter element from multiple directions at the bottom of the filter element. In on preferred embodiment, the filter element is provided with six water inlet holes at the end of the filter element. More preferably, the water inlet holes are circumferentially distributed.

For the filter element, a cylindrical shape is a preferred shape, and the cylindrical filter element matches the water inlet holes which are circumferentially distributed. The water entering the water inlet flows through the filter material in six directions, and flows out from the water outlet after being filtered and softened.

In one embodiment of the present disclosure, the filter element further comprises at least two sealing ribs arranged on the inner surface at the lower end of the filter element body and a sealing gasket contained in the cavity at the bottom of the filter element body; wherein the sealing gasket includes at least two sealing groove adapted to the sealing ribs. The sealing ribs on the inner surface at the lower end of the filter element body and the sealing gasket contained in the cavity at the bottom of the filter element body form a sealing assembly for sealing the filter element. In the sealing assembly, the sealing ribs and the sealing grooves are engaged closely with each other to form a sealing structure to prevent water from leaking from the cavity of filter element along the inner wall of the filter element body. In a preferred embodiment, the filter element body is provided with 6 sealing ribs on the inner surface at the bottom of the filter element body, and the sealing gasket is provided with six sealing grooves adapted to the sealing ribs. In one preferred embodiment, By using the combination of six sealing ribs and six sealing grooves, the filter element and the sealing gasket can be engaged more tightly, and reliable sealing can be realized. In another preferred embodiment, the sealing gasket includes a columnar part and at least three bosses arranged circumferentially on the end surface of the columnar part, and a recess is provided between every two bosses, and the recess runs through diagonally or transversely between two adjacent bosses.

In one embodiment of the present disclosure, the filter element further comprises a base for fixing the filter element, and the base comprises a base body, a water outlet hole, a clamping rib, and a protrusion;

wherein the base body is provided with the water outlet hole at the center of the base body and the base body is provided with clamping ribs circumferentially distributed on the surface of the base body, and the clamping ribs are adapted to clamp to the lower end of the filter element body;

the base body is provided with at least three protrusions on the surface of base body proximal to water outlet hole relative to the clamping rib, and the protrusions are configured to engage with the recesses of the sealing gasket.

In one embodiment of the present disclosure, the outlet water filter mesh comprises a tapered connection pipe protruding from the center of the outlet water filter mesh, and the tapered connection pipe is provided with a boss provided on the outer surface of the tapered connection pipe so that boss is sleeved into the central pipe to prevent the activated carbon from flowing out of the inlet of the filter element.

In another aspect, the present disclosure provides a sealing assembly for a filter element, and the sealing assembly comprises a sealing gasket and a base body, wherein the sealing gasket includes a columnar part and at least three bosses arranged circumferentially on the end surface of the columnar part, the columnar part is provided with a central hole allowing for water to pass through, a recess is provided between every two bosses, and the recess runs through diagonally or transversely between two adjacent bosses;

the filter element body of the sealing assembly is provided with at least one slit distributed circumferentially in a cavity at the lower end of the filter element body;

the inner surface of the lower end of the filter element body is provided with at least two sealing ribs, and the cavity at the lower end of the filter element body is provided with a sealing gasket, and the sealing rubber gasket includes at least one sealing groove adapted to the at least two sealing ribs ;

wherein the sealing gasket includes a columnar part and at least three bosses arranged on an end surface of the columnar part, and a recess is provided between every two bosses that are distributed circumferentially, and the recess runs through diagonally or transversely between two adjacent bosses;

the base body is provided with a water outlet hole at the center of the base body, and the base body is adapted to closely contact to both the bosses and the recesses on the sealing gasket or the base body is adapted to closely contact to the end surface of the sealing gasket to achieve sealing between the sealing gasket and the base body

In one embodiment of the sealing assemble of the present disclosure, the end surface of the boss, which is away from the columnar part and the surfaces of the recesses between every two adjacent bosses, are in close contact with the base body to form a sealed area. In this sealing arrangement, the sealing effect is achieved through close contact in the longitudinal direction between the base body and the surfaces of both the boss and the recesses on the gasket.

In one embodiment of the sealing assembly of the present disclosure, the end surface on the columnar part that carries the bosses is in close contact with the base body to form a sealed area. In this sealing arrangement, the sealing effect is achieved through the close contact between the base body and the end surface of the gasket body in the longitudinal direction.

In one embodiment of the sealing assembly of the present disclosure, the number of the bosses is six, and the number of the recesses is six.

In the sealing assembly of the present disclosure, the material constituting the gasket body may be rigid or elastic. In the case where the material of the gasket body is rigid, the sealing effect can be further realized by the elastic sealing pad. In the case where the material of the gasket body is elastic, a better sealing effect can be achieved due to the elastic nature of the material itself, without using an additional sealing pad.

In one embodiment of the sealing assembly of the present disclosure, the sealing gasket further includes at least two sealing grooves arranged on the side of the sealing gasket, and the sealing grooves are adapted to cooperate with at least two sealing ribs to achieve sealing. By using this arrangement, the sealing gasket can be jammed with at least two sealing ribs provided on the inner surface of the lower end of the filter element body, thereby further improving the sealing performance of the filter element. In a specific embodiment of the sealing assembly of the present disclosure, the number of the sealing grooves is six, and the number of the sealing ribs is six.

In one embodiment of the sealing assembly of the present disclosure, the base body is provided with clamping ribs circumferentially distributed on the surface of the base body, and the clamping ribs are adapted to clamp to the slits provided at the lower end of the filter element body. More preferably, the clamping rib is provided with at least three protrusions on the surface of base body proximal to water outlet hole relative to the clamping rib, and the protrusions are in close contact with the recesses of the sealing gasket, thereby realizing the sealing of the sealing assembly. In a specific embodiment of the sealing assembly of the present disclosure, the number of the protrusions is 6 so that protrusions are adapted to the 6 recesses on the gasket.

In yet another aspect, the present disclosure provides a coffee machine including the filter element described in the present disclosure.

### DETAILED DESCRIPTION OF THE DRAWINGS

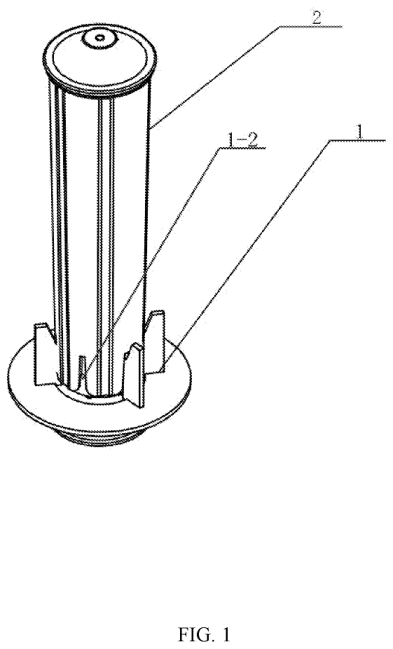

FIG. 1 is a structural diagram of the filter element of the present disclosure;

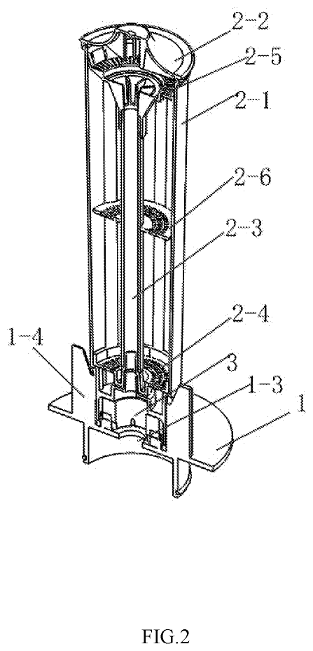

FIG. 2 is a cross-sectional view of the filter element of the present disclosure;

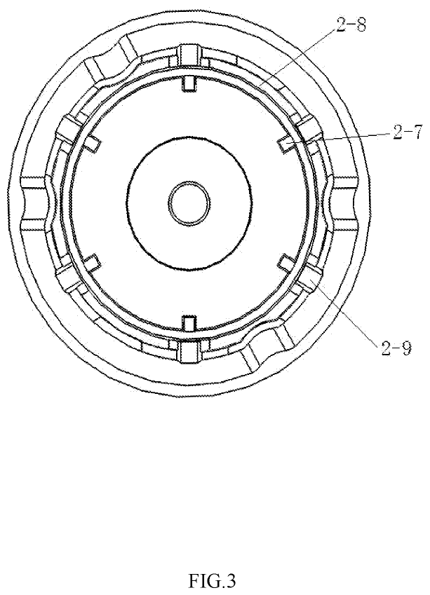

FIG. 3 is a bottom view of the filter element of the present disclosure;

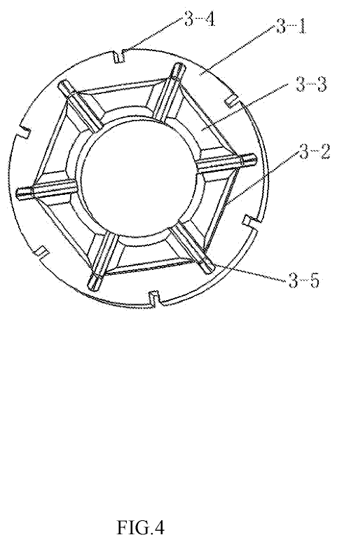

FIG. 4 is a top view of the sealing gasket in the filter element of the present disclosure;

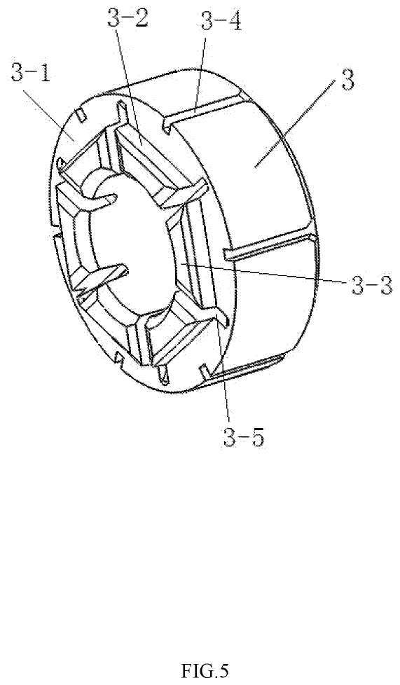

FIG. 5 is a perspective view of the gasket of the filter element of the present disclosure;

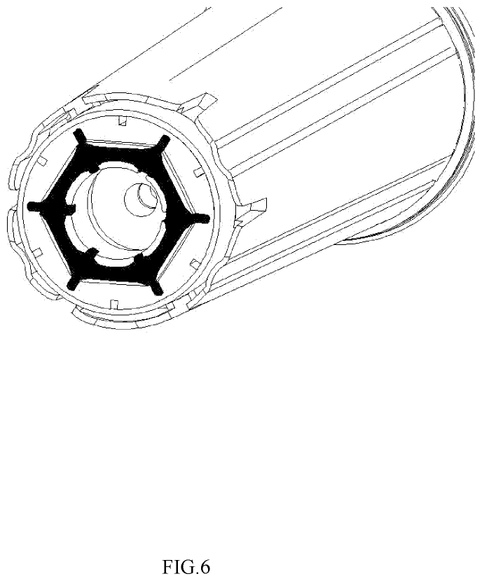

FIG. 6 is a schematic diagram of the sealing area in one sealing arrangement of the sealing gasket;

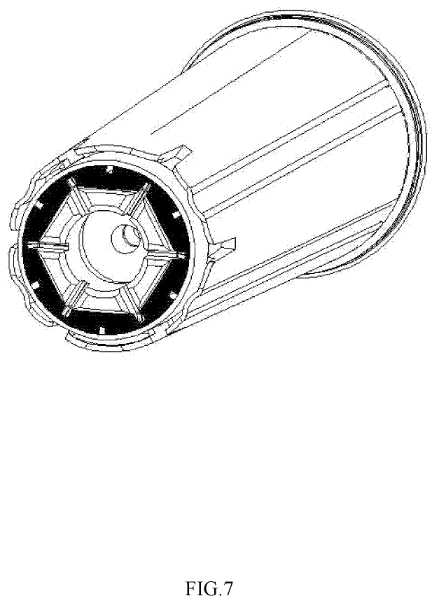

FIG. 7 is a schematic diagram of the sealing area in another sealing arrangement of the sealing gasket;

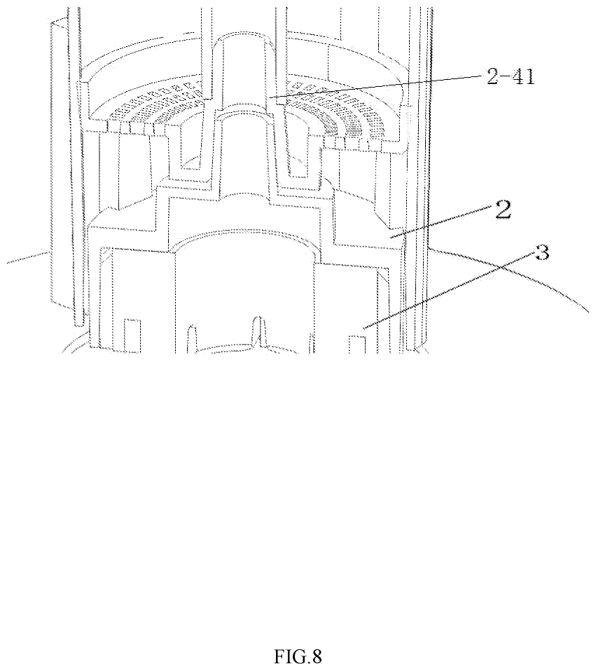

FIG. 8 is a sectional view of the assembly of the sealing gasket and the bottom part of the filter element of the present disclosure;

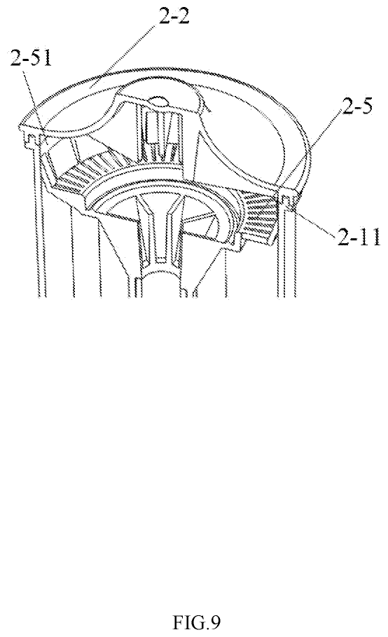

FIG. 9 is a cross-sectional view of the connection between the filter element and the end cap of the present disclosure;

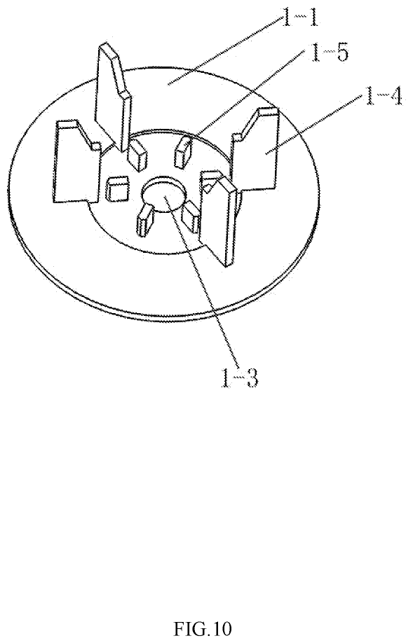

FIG. 10 is a structural diagram of the base of the filter element of the present disclosure;

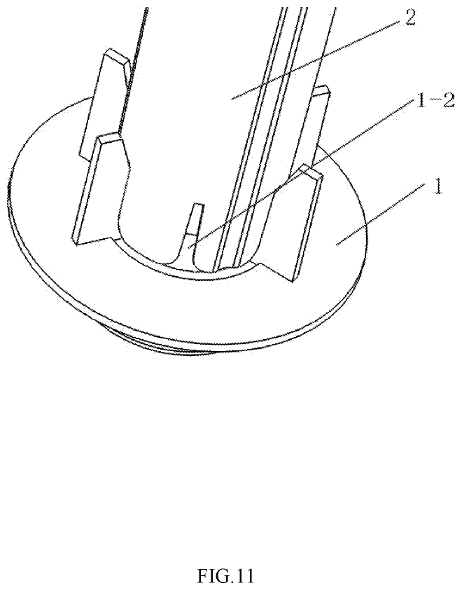

FIG. 11 is a schematic diagram of assembly of the base of the filter element and the filter element of the present disclosure;

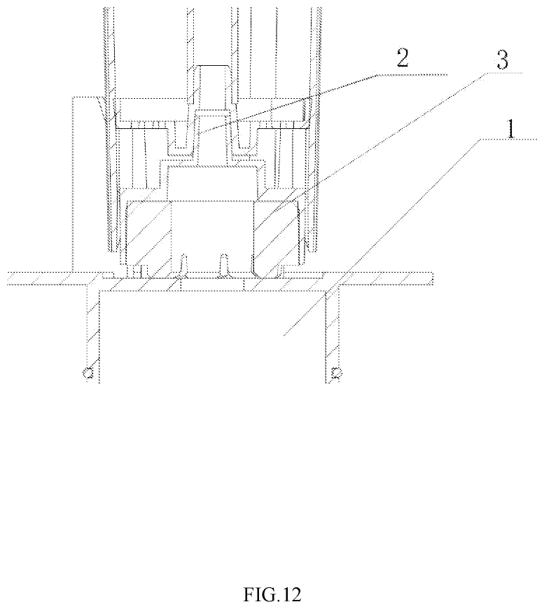

FIG. 12 is a cross-sectional view of the assembly of the base and the filter element of the present disclosure;

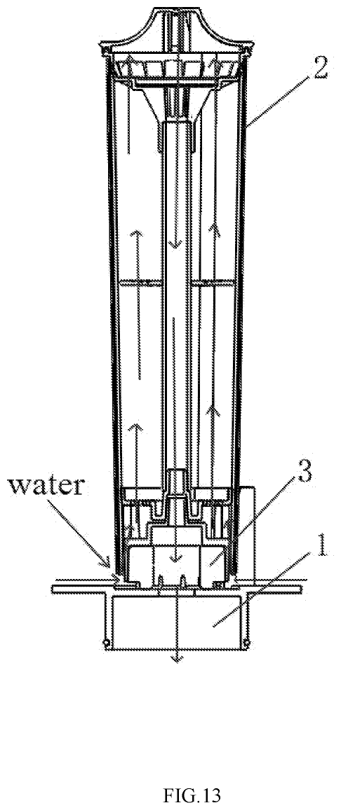

FIG. 13 is a schematic diagram of the water flow path when the filter element of the present disclosure is in use.

### REFERENCE SIGNS

1: base; 2: filter element; 3: sealing gasket;

1-1: base body; 1-2: water inlet; 1-3: water outlet; 1-4: clamping rib; 1-5: protrusion;

2-1: element body; 2-2: end cap; 2-3: central pipe; 2-4: water inlet grid; 2-41: boss for water inlet grid;

2-5: water outlet grid; 2-51: leg of water outlet grid;

2-6: partition grid; 2-7: sealing rib; 2-8 water inlet hole; 2-9: water inlet rib;

3-1: gasket body; 3-2: boss; 3-3: end surface at top of the boss; 3-4: sealing groove; 3-5: recess.

### DETAILED DESCRIPTION OF THE EMBODIMENTS

The present disclosure will be further described below in conjunction with the drawings and embodiments. In the present disclosure, the expression for the relative position, for example, “upper”, “lower”, “top”, “bottom”, “outer” directional terms “inner” and the like are merely for purpose of explanation and not intended to limit the scope of the present disclosure. In present disclosure, these orientation expressions are mainly based on the directions shown in FIG. 1.

As shown in FIG. 1, a schematic view of the filter assembly of the present disclosure is shown. In FIG. 1, the filter element assembly includes a base 1, a filter element 2, a water inlet 1-2 and a water outlet (not shown), and an end cap 2-2.

FIG. 2 is a cross-sectional view of the filter element of the present disclosure. In FIG. 2, the filter element 2 includes a filter element body 2-1, an end cap 2-2, a central pipe 2-3, a water inlet grid 2-4, a water outlet grid 2-5, and a partition grid 2-6. The end cap 2-2 is installed on the top of the filter element body 2-1, the water inlet grid 2-4 is installed on the bottom of the filter element body 2-1, and the central pipe 2-3 is arranged in cavity of the filter element body and extends longitudinally. In in the middle of the cavity of the filter element body, a partition grid 2-6 is installed. The partition grid 2-6 divides the filter element body into two chambers. The first chamber is located at the upper part of the filter element body and filled with resin, and the second chamber is located at the lower part and filled with activated carbon.

The central pipe 2-3 passes through the partition grid 2-6. One end of the central pipe 2-3 is connected to the water inlet grid 2-4 at the water inlet, and the other end is connected to the water outlet grid 2-5 provided at the water outlet. The partition grid 2-6 surrounds the outer wall of the central pipe and extends to the inner wall of the filter element body so that water enters from the six water inlet ribs 2-9 (shown in FIG. 3) which are located at the water inlet and spaced with each other and flows through the first chamber filled with adsorption filter material (activated carbon) and through the second chamber filled with ion exchange filter material (ion exchange resin). And water flows into the central pipe from the water outlet grid 2-5 at the water outlet, and then the water flows out from the other end of the central pipe.

In the present disclosure, the upper and lower sides of the partition grid 2-6 arranged in the filter element are separately filled with activated carbon and resin, avoiding clumping (caking) of filter material caused by the mixing of the filter materials. In addition, filter grids can be arranged at the water inlet, at the water outlet, and within the filter element, which not only increases the water passage area of the filter element, but also avoids reduction in water volume caused by the uneven precision of the PE and/or PP sintered filter material in the filter element.

In order to ensure the sealing of the filter element, an elastic rubber sealing gasket 3 is provided at the bottom of the filter element. As shown in FIG. 4 and FIG. 5, the rubber sealing gasket 3 is composed of a rubber gasket body 3-1, a boss 3-2, a sealing groove 3-4 and a recess 3-5. The rubber gasket body 3-1 has a cylindrical structure, and the sealing groove 3-4 is opened on the side of the cylindrical rubber gasket body. As shown in FIG. 4, six sealing grooves 3-4 are provided, the sealing grooves are distributed in equal space along the circumference of the cylindrical rubber sealing gasket 3. The end surface of the rubber gasket body 3-1 can be adapted to form multiple sealing positions with the bosses 3-2. Correspondingly, there are six recesses 3-5 between adjacent sealing positions (between the bosses 3-2).

There are mainly two manners for sealing the bottom of the filter element in the present disclosure.

The first sealing manner is described as follows.

The end surfaces at top of the boss 3-3 of the six bosses 3-2 on the surface of the rubber sealing gasket 3 and the surfaces of the recesses 3-5 between every two adjacent bosses 3-2 form a sealed area. In other words, the sealing area is formed by the end surfaces at top of the boss 3-3 and the surface of the recess 3-5, and sealing is achieved by blocking the end surfaces at top of the boss 3-3 and the recess 3-5. The sealed area is shown as the black filled area in FIG. 6. It can be envisaged from FIG. 6 that the sealing between the filter element and the base is achieved through the contact between the surfaces of the two parts (i.e. the base and the rubber sealing gasket) in the longitudinal direction of the filter element.

The second sealing manner is described as follows.

On the bearing surface of the rubber sealing gasket 3 where with the bossed 3-2 are provided, a sealing area is formed on the remaining area on the bearing surface when the areas occupied by the boss 3-2 and the recess 3-5 are excluded, and sealing is achieved by blocking the end surface of the rubber sealing gasket. The sealed area is shown as the black filled area in FIG. 7.

The rubber sealing gasket 3 is installed in such a manner that one end of the sealing rubber gasket 3 is installed in the cavity at the bottom of the filter element, and the sealing groove 3-4 of the sealing rubber gasket and the sealing ribs 2-7 on the inner surface in the cavity at the bottom of the filter element (see FIG. 3) are jammed tightly. The six bosses 3-2 and six recesses 3-5 on the other end of the rubber sealing gasket 3 cooperate with the base 1 to form a sealing structure.

In the two exemplary sealing manners mentioned above, both of the two sealing manners involve close contact of at least two surfaces in the longitudinal direction of the filter element. In addition, a hexagonal arrangement is formed between the six bosses 3-2. This hexagonal arrangement not only allows the filter element to be clamped more tightly, but also achieves better sealing performance.

As shown in FIG. 9, the upper part of the filter element body 2-1 is provided with an annular male half-coupling 2-11 which is engaged with the female half-coupling of the end cap 2-2, and the male half-coupling and the female half-coupling are welded by ultrasound to form a sealing structure on the top of the filter element. The top of the inner cavity of the filter element body is coupled to the water outlet grid feet 2-51 so that the water outlet grid 2-5 is clamped in the cavity of the filter element body.

As shown in FIG. 10, the base 1 is composed of a base body 1-1, a water outlet 1-3, a clamping rib 1-4 and a protrusion 1-5. The water outlet 1-3 is arranged in the center of the base body 1-1 for receiving water from the central pipe 2-3. The upper surface of the base body 1-1 is provided with four clamping ribs 1-4 that are distributed circumferentially, and the clamping ribs 1-4 are clamped at the lower end of the filter element body 2-1. Six protrusions 1-5 are provided on the inner side of the clamping rib 1-4. The protrusions 1-5 and the rubber sealing gasket 3 are in close contact with each other to form the sealed area, and the sealed area are attached to the recesses 3-5 to realize the sealing of the rubber sealing gasket.

The structure of the base 1 and the filter body 2-1 after being clamped is shown in FIG. 11.

In this embodiment, the water inlet grid 2-4 is provided with a water inlet grid boss 2-41 at the center of the water inlet grid 2-4 (see FIG. 8). The boss for water inlet grid 2-41 are sleeved in the water outlet of the central pipe 2-3 to prevent the activated carbon from flowing out of the water inlet of the filter element.

In order to ensure the tightness between the filter element and the coffee machine, an annular groove is provided on the outer periphery of the lower end of the base (see FIG. 12), and the annular groove is used to accommodate an elastic O-ring. After the filter element of the present disclosure is installed on the coffee machine, the sealing between the filter element and the coffee machine is realized by the adhesion between the O-ring and the coffee machine, and the leakage of water from the filter element is prevented.

When using the filter element of the present disclosure, water that has been preliminarily filtered is introduced into the filter element from the water inlet on the lower end of the filter element, and the water enters the filter element through the water inlet at the bottom of the filter element, and is filtered through activated carbon and resin in sequence. The purified water after the filtration is discharged from the water outlet at the lower end of the central pipe, and finally enters the coffee machine through the central hole of the base. The flow path of the water is shown in FIG. 13.

In the present disclosure, the filter element body is divided into two chambers (the primary filter cavity and the secondary filter cavity of the filter element) by a partition grid. The two chambers realize filling of filter materials at two stages, preventing the filtering material from being mixed and causing caking due to long-term use of the filter material. At the same time, it also prevents small particles from clogging the resin gap and causing reduced water flow or even interruption of water flow. Using the filter element of the present disclosure can not only extend the service life of the filter element, but also improve work efficiency of the coffee machine the using the filter element of the present disclosure.

The present disclosure also provides a coffee machine comprising the filter element of the present disclosure. As for the cooperation between the filter element and the coffee machine, those skilled in the art have the ability to design according to the structure of the base, which will not be repeated herein.

What is claimed is:

1. A sealing assembly for a filter element comprising a sealing gasket and a base body, wherein the sealing gasket includes a columnar part and at least three bosses arranged circumferentially on the end surface of the columnar part, the columnar part is provided with a central hole allowing water to pass through, a recess is provided between every two bosses, and the recess runs through diagonally or transversely between two adjacent bosses;
the base body is provided with a water outlet hole at the center of the base body, and the base body is adapted to closely contact both the bosses and the recesses on the sealing gasket, or the base body is adapted to closely contact the end surface of the sealing gasket to achieve sealing between the sealing gasket and the base body.

2. The sealing assembly according to claim 1, wherein the end surface of the boss, which is away from the columnar part and the surfaces of the recesses between every two adjacent bosses, are in close contact with the base body to form a sealed area.

3. The sealing assembly according to claim 1, wherein the end surface on the columnar part that carries the bosses is in close contact with the base body to form a sealed area.

4. The sealing assembly according to claim 1, wherein the sealing gasket further includes at least two sealing grooves arranged on the side of the sealing gasket, and the sealing grooves are adapted to cooperate with at least two sealing ribs to achieve sealing.

5. The sealing assembly according to claim 4, wherein further preferably, the number of the sealing grooves is 6, and the number of the sealing ribs is 6.

6. The sealing assembly according to claim 1, wherein the base body is provided with clamping ribs circumferentially distributed on one surface of the base body, and the clamping ribs are adapted to clamp to the slits provided at the lower end of the filter element body.

7. The sealing assembly according to claim 6, wherein the clamping rib is provided with at least three protrusions on the surface of base body proximal to water outlet hole relative to the clamping rib, and the protrusions are in close contact with the recesses of the sealing gasket.
